(19) United States
(12) Patent Application Publication
(10) Pub. No.: US 2005/0258206 A1
(43) Pub. Date: Nov. 24, 2005

(54) Webbing clamp for golf game

(76) Inventor: Fu-Hsing Tan, Guangdong (CN)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/127,537

(22) Filed: May 12, 2005

(30) Foreign Application Priority Data
May 19, 2004 (CN) 2004-20045913.7

(51) Int. Cl. B60R 9/00; A63B 55/00

(52) U.S. Cl. 224/274

(57) ABSTRACT

A clamp for golf game of the invention includes a base panel; and a top panel to partially connect with the base panel; wherein a plurality of first protruding teeth are provided on a surface of the base panel facing to the top panel; and a plurality of second protruding teeth are provided on a surface of the top panel facing to the base panel, which are positioned corresponding to concaves defined by the first protruding teeth of the base panel. The clamp can make a golf bag be attched/fixed onto a golf cart/trolley firmly.

### FIELD OF THE INVENTION

The present invention relates to an apparatus for golf game, and more particularly to a webbing clamp for golf game which can bind a golf bag to a golf cart/trolley firmly using the strap on golf cart/trolley.

### BACKGROUND OF THE INVENTION

In golf game, a golf bag is generally put on to a golf cart for moving the golf bag conveniently. At present, a conventional method to bind the golf bag to the golf cart is as follows: providing two trolley strap with a buckle on each end of strap, wherein the two buckles can close each other completely; and then round the trolley strap on the top frame collar of the golf bag, close two buckles with each other, and fastening the strap to finish binding of the golf bag with the golf cart.

However, the conventional binding method has the following drawbacks as follows: firstly, the binding is not firm enough so that the golf bag easily rotates relative to the golf cart. The conventional binding method utilizes a friction force between the strap and the top frame of the golf bag to fix the golf bag; however, the friction force is not very large because the strap can not be fastened firmly so that the strap is easy to loosen and then the golf bag can not be bond firmly after long-time using, repetitious sway during movement. So, there is a danger that some golf apparatus are damaged if the golf bag is loosened. Secondly, a surface of the top frame collar of the golf bag is easily to be abrased because the strap frequently abrase with the surface of the top frame so as to shorten the lifespan of the golf bag.

Hence it is desired to provide a clamp for golf game which can overcome the foregoing drawbacks of the prior art.

### SUMMARY OF THE INVENTION

A main object of the present invention is to provide a webbing clamp for golf game, which can bind a golf bag to a golf cart/trolley firmly and prevent abrasion on the top frame of the golf bag.

To attain the object of the present invention, a webbing clamp for golf game of the invention comprises a base panel; and a top panel to partially connect with the base panel; wherein a plurality of first protruding teeth are provided on a surface of the base panel facing to the top panel; and a plurality of second protruding teeth are provided on a surface of the top panel facing to the base panel, which are positioned corresponding to concaves defined by the first protruding teeth of the base panel. In the invention, a waveform shape is formed between top portions of the first protruding teeth and the second protruding teeth. The first protruding teeth and the second protruding teeth are arranged vertically.

In an embodiment, there is an angle between the top portion of the protruding tooth on the base panel and the top portion of the protruding tooth on the top panel. The base panel and the top panel are coupled together with their bottoms. There are three screw holes provided on the base panel. The base panel is larger than the top panel.

In a further embodiment, the clamp further comprises a closure system to fastening the top panel and the base panel. The closure system comprises a tab portion extending from the base panel; the tab portion comprising a protrusion on its inner side adjacent to a free end thereof, while the top panel comprising a socket portion with a groove formed therein for receiving the protrusion. Selectively, the closure system comprises a tab portion on the base panel; the tab portion comprising a groove on its inner side adjacent to a free end thereof, while a protrusion is formed on the top panel for receiving the protrusion.

Comparing with the prior art, the clamp of the invention can increase friction force between the clamp and a strap due to the first and second gear-shaped protruding teeth so as to fix the strap to the clamp connected to the head frame of the golf bag firmly. So the golf bag will not sway relative to the golf because of the long-time using thereof. In addition, there is an angle between the top portion of the protruding tooth on the base panel and the top portion of the protruding tooth on the top panel so that the straps with different thickness can be fixed in the clamp. For example, a thinner strap can be stuffed into a bottom of the clamp which having a little space. Also, some paraphernalia, such as towel, key and food bag can be hung on the flying ring of the top panel.

For the purpose of making the invention easier to understand, some particular embodiments thereof will now be described with reference to the appended drawings in which:

### DESCRIPTION OF THE DRAWINGS

FIG. 1 is a plan view of a clamp for golf game according to an embodiment of the invention;

FIG. 2 is a top view of the clamp of FIG. 1;

FIG. 3 is a side view of the clamp of FIG. 1;

FIG. 4 is a cross-sectional view of FIG. 1 taken along line A-A;

FIG. 5 shows the clamp of FIG. 1 being used.

FIGS. 6-9 are sketch views of a clamp for golf game according to a second embodiment of the invention;

FIGS. 10-11 are sketch views of a clamp for golf game according to a third embodiment of the invention;

FIGS. 12-13 are sketch views of a clamp for golf game according to a fourth embodiment of the invention;

FIGS. 14-15 is a sketch view of a clamp for golf game according to a five embodiment of the invention;

### DETAILED DESCRIPTION OF THE INVENTION

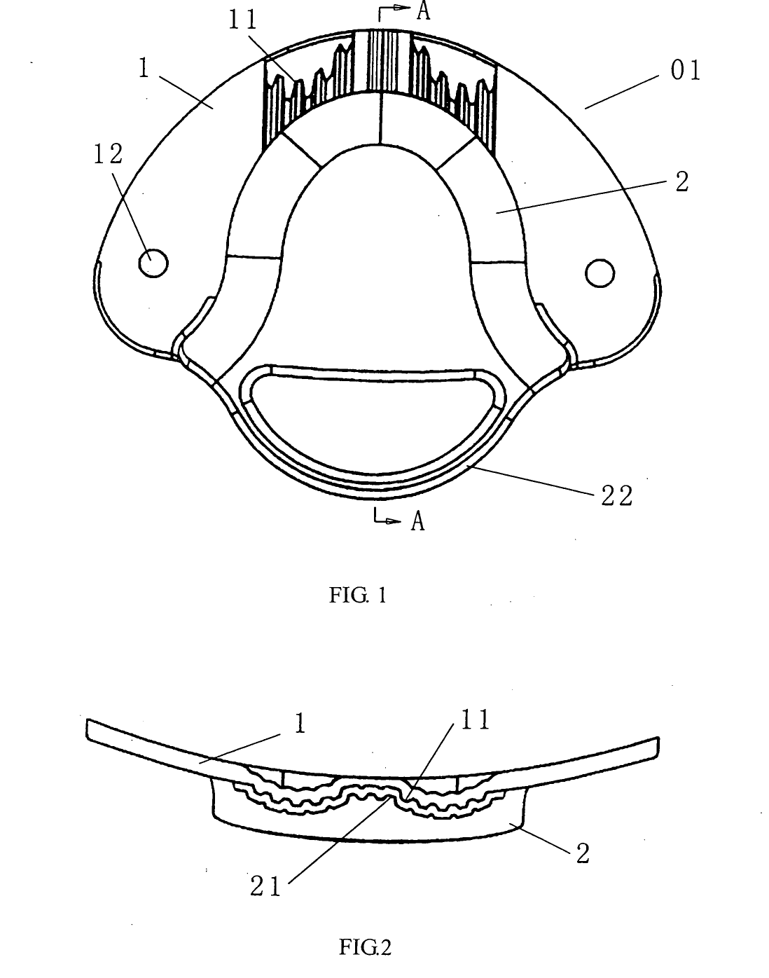

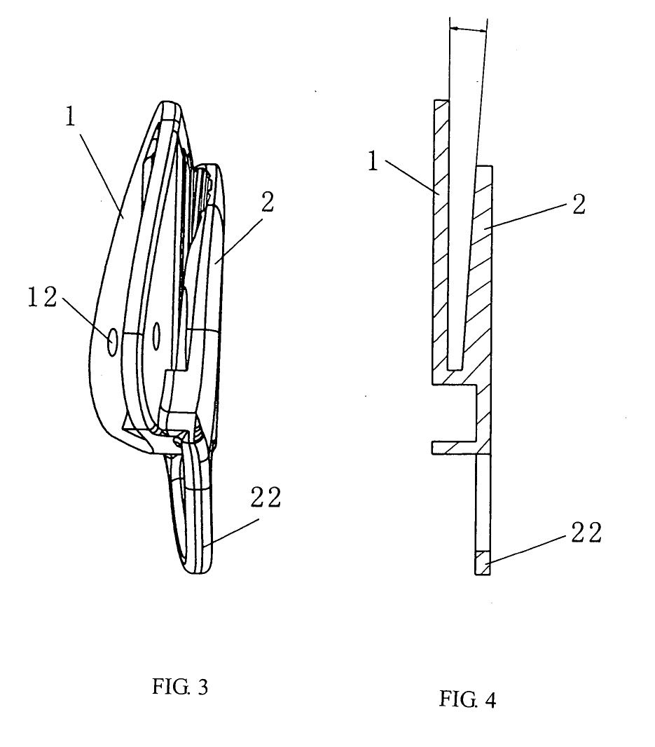

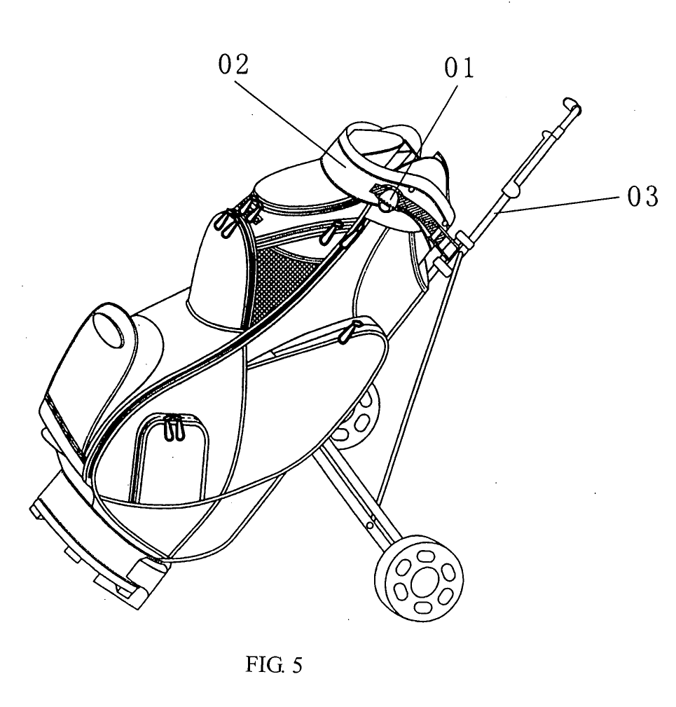

Referring now to the drawings in detail, as shown in FIGS. 1-4, according to an embodiment of the invention, a webbing clamp 01 for golf game comprises of a base panel 1 and a top panel 2. The base panel 1 and the top panel 2 are coupled together with their bottoms. A plurality of protruding teeth 11 are provided on a surface of the base panel 1 facing to the top panel 2; while a plurality of the protruding teeth 21 are provided on a surface of the top panel 2 facing to the base panel 1. The protruding teeth 21 are positioned corresponding to concaves defined by the protruding teeth 11 of the base panel 1. A waveform shape is defined between the top portions of the protruding teeth 11 and the protruding teeth 21 which are arranged vertically. There is an angle between the top portion of the protruding tooth 11 on the base panel 1 and the top portion of the protruding tooth 21 on the top panel 2, thus making the space of an opening between the base panel 1 and the top panel 2 become larger, while the space between the protruding teeth 11 and the protruding teeth 21 on the coupled bottoms of the base panel 1 and the top panel 2. In addition, there are two screw holes 12 provided on two side ends of the base panel 1. Another screw hole (not shown) is provided on a top portion of the base panel 1. In the present invention, the base panel 1 is larger than the top panel 2 so as to provide a base for the whole clamp 01, and the clamp 01 can be fixed onto a golf bag 02 (see FIG. 5) by rivet (not shown). According to an embodiment of the invention, a semicircular flying ring 22 is coupled on the top panel 2.

During usage of the clamp 01, referring to FIG. 5, firstly, fixing the two clamps 01 on both sides of a top frame collar of a golf bag 02. When it is required to fix the golf bag 02 to the golf cart/trolley 03, it only needs to sandwich cart/trolley straps (not labeled) which attached on the golf cart/trolley 03 in the clamp 01 firmly.

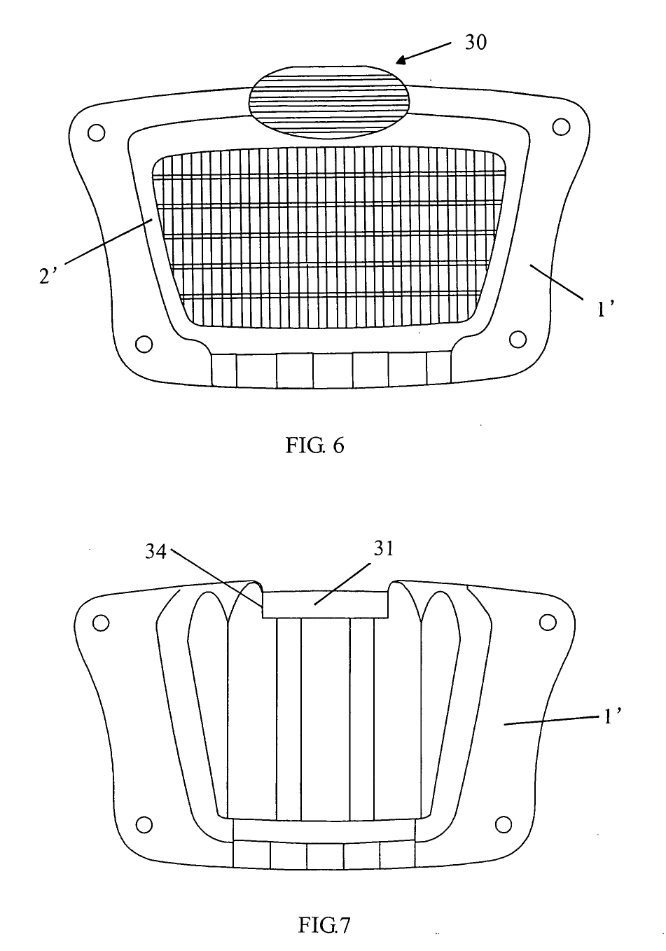

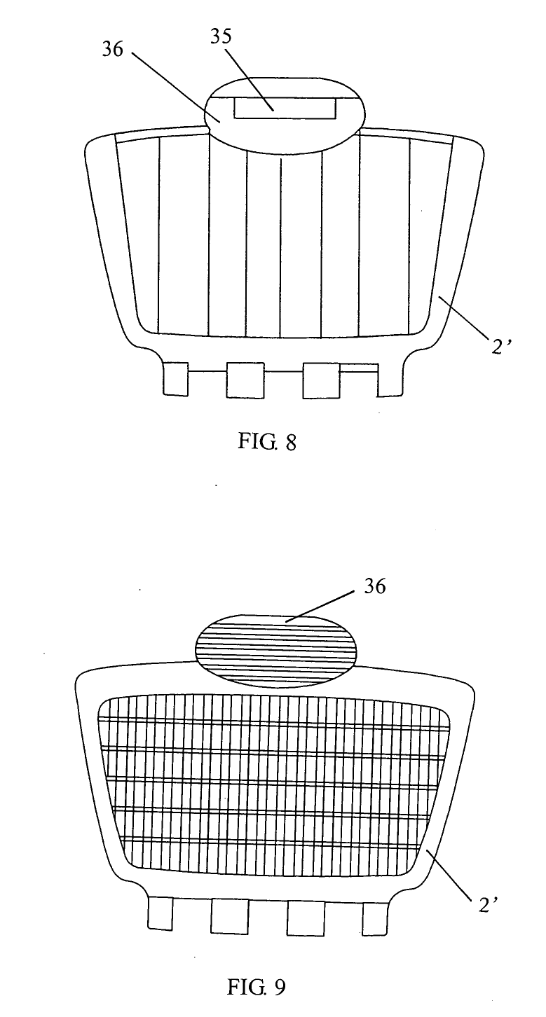

According to an embodiment of the invention, referring to FIGS. 6-9, the clamp may further comprise a closure system 30 for fastening the top panel 2′ and the base panel 1′. The closure system 30 comprises a tab portion 31 extending from the base panel 1. The tab portion 31 comprises a protrusion 34 on its inner side adjacent to a free end thereof. Correspondingly, the top panel 2 comprises a socket portion 36 with a groove 35 formed therein for receiving the protrusion 34 so as to fasten the top panel 2′ and the base panel 1′ more firmly. Obviously, the groove 35 can be formed on the base panel 1′, and the protrusion 34 can be formed on the top panel 2′.

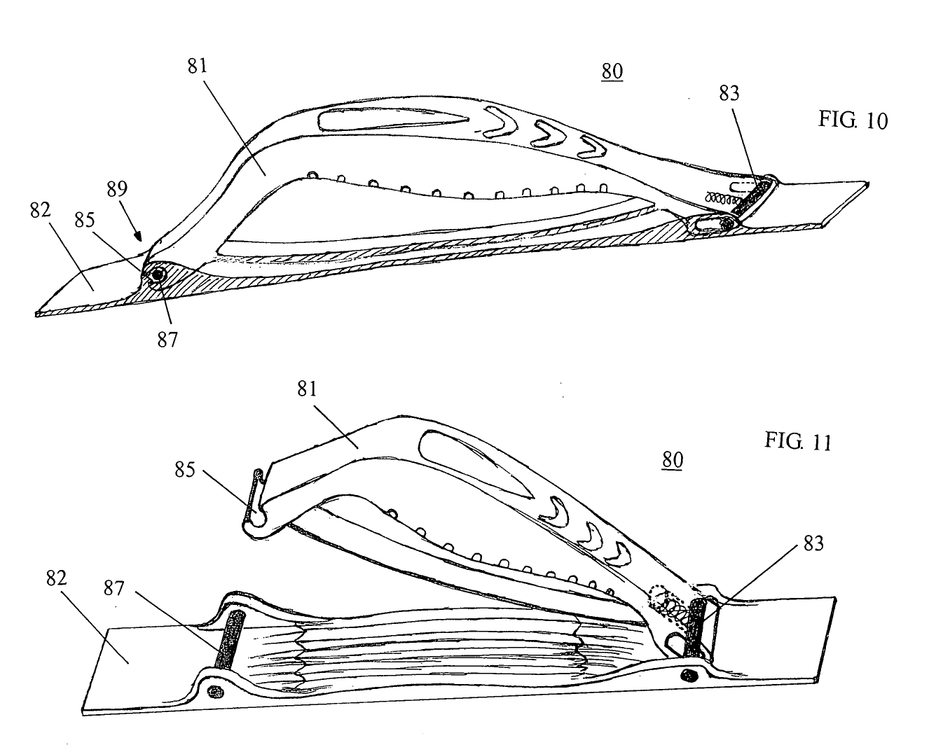

According to another of the invention, referring to FIGS. 10-11, a webbing clamp 80 comprises a base 82 and a handle portion 81 to connect with the base 82 in an end thereof by a first pivot 83. The handle clamp 80 also comprises a closure system 89 for fastening the handle portion 81 and the base 82. The closure system 89 comprises a notch 85 formed in another end of the handle portion 81 and an engaging rod 87 formed in the base 82 corresponding to the notch 85. When the strap extends through the clamp, the handle portion 81 can be rotate downwardly with the first pivot 83 as a rotation axis so as to make the notch 85 engage with the engaging rod 87, thus fixing the handle portion 81 with the base 82 firmly. By this way, the webbing clamp 80 can fasten golf cart/trolley strap firmly, so a golf bag can be fixed onto the golf cart/trolley firmly.

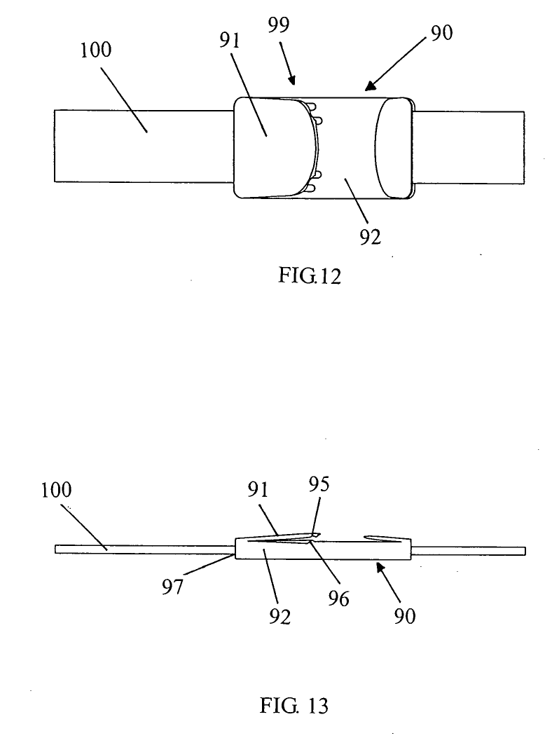

According to a further embodiment of the invention, referring to FIGS. 12-13, a webbing clamp 90 comprises a top panel 91 and the base panel 92 are connected together at the both ends of clamp 90. A passage 97 is defined by the top panel 91 and the base panel 92 of the clamp 90 for a strap 100 on a golf bag to extend through. When the strap 100 of a golf bag extends through the clamp 90, then the clamp 90 is attached onto the golf bag. The clamp 90 can move up and down along the strap of the golf bag to change its position easily so as to make the clamp 90 match any height of the strap on the golf cart/trolley.

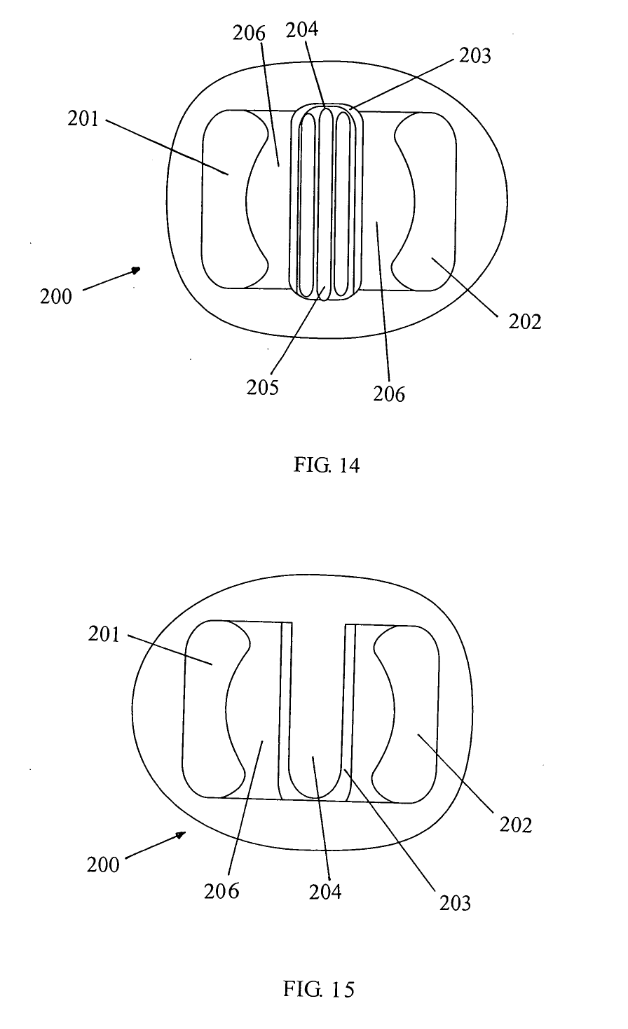

According to a further embodiment of the invention, referring to FIGS. 14-15, a webbing clamp 200 comprises two bar openings 201, 202 formed at two sides thereof and a semi-annular opening 203 formed in a middle protion thereof. A first engaging portion 204 is defined by the semi-annular opening 203, which has a plurality of bar protrusions 205 formed on one side thereof for increasing fiction force between a strap and the clamp 200. Two second engaging portions 206 are defined by the two bar openings 201, 202 and the semi-annular opening 203 so as to increase fiction force between the strap and the clamp 200. For example, the strap can be inserted into a half opening of the semi-annular opening 203. Due to the assembly of the strap with the clamp 200, the strap will contact with the first and second engaging portions 204, 206 closely so as to attain a large firction force and prevent the strap from moving relative to the clamp 200.

It is understood that the invention may be embodied in other forms without departing from the spirit thereof. Thus, the present examples and embodiments are to be considered in all respects as illustrative and not restrictive, and the invention is not to be limited to the details given herein.

1. A webbing clamp for golf game, which comprising:
a base panel; and
a top panel to partially connect with the base panel;
wherein a plurality of first protruding teeth are provided on a surface of the base panel facing to the top panel; and
a plurality of second protruding teeth are provided on a surface of the top panel facing to the base panel, which are positioned corresponding to concaves defined by the first protruding teeth of the base panel.

2. The webbing clamp as claimed in claim 1, wherein a waveform shape is formed between top portions of the first protruding teeth and the second protruding teeth.

3. The webbing clamp as claimed in claim 1, wherein the first protruding teeth and the second protruding teeth are arranged vertically.

4. The webbing clamp as claimed in claim 1, wherein there is an angle between a top portion of the first protruding tooth on the base panel and a top portion of the second protruding tooth on the top panel.

5. The webbing clamp as claimed in claim 1, wherein the second protruding teeth can be taper-shaped with an angle formed with the based panel.

6. The webbing clamp as claimed in claim 1, wherein the base panel and the top panel are coupled together with their bottoms/ends.

7. The webbing clamp as claimed in claim 1, wherein there are holes provided on the base panel for riveting or fixing the clamp onto a golf bag.

8. The webbing clamp as claimed in claim 1, wherein the base panel is larger than the top panel.

9. The webbing clamp as claimed in claim 1, further comprising a closure system to fasten the top panel and the base panel.

10. The webbing clamp as claimed in claim 9, wherein the closure system comprises a tab portion extending from the base panel; the tab portion comprising at least one protrusions on its inner side adjacent to a free end thereof, while the top panel comprising a socket portion with at least one groove formed therein for receiving the protrusion.

11. The webbing clamp as claimed in claim 9, wherein the closure system comprises a tab portion on the base panel; the tab portion comprising at least one grooves on its inner side adjacent to a free end thereof, while at least one protrusions are formed on the top panel for receiving the protrusion.

12. A webbing clamp for golf game, which comprising:
two bar openings formed at two sides thereof; and
a semi-annular opening formed in a middle protion thereof.

13. The webbing clamp as claimed in claim 12, wherein a first engaging portion is defined by the semi-annular opening; and two second engaging portions are defined by the two bar openings and the semi-annular opening.

14. The webbing clamp as claimed in claim 13, wherein a plurality of bar protrusions formed on the first engaging portion.
